(19) United States
(12) Patent Application Publication
(10) Pub. No.: US 2012/0290496 A1
(43) Pub. Date: Nov. 15, 2012

(54) METHOD OF CALCULATING DELIVERY OPERATION WORKLOAD AND APPARATUS FOR THE SAME

(75) Inventor: Jeong Hyun PARK, Daejeon (KR)

(73) Assignee: Electronics and Telecommunications Research Institute, Daejeon (KR)

(21) Appl. No.: 13/467,944

(22) Filed: May 9, 2012

(30) Foreign Application Priority Data
May 13, 2011 (KR) 10-2011-0045107

(51) Int. Cl. G06Q 50/28

(52) U.S. Cl. 705/338

(57) ABSTRACT

A method of calculating a delivery operation workload and an apparatus for the same are disclosed. The method includes calculating a route sorting time on the basis of given same-day mail delivery information and delivery point information, calculating a movement time on the basis of the same-day mail delivery information and the delivery point information, calculating a delivery time on the basis of the same-day mail delivery information and the delivery point information, calculating an incidental operation time on the basis of the same-day mail delivery information and the delivery point information, and summing the calculated route sorting time, the movement time, the delivery time, and the incidental operation time, and calculating the delivery operation workload on the basis of processing ability information for each mailman and delivery operation environment information. It is thus possible to more objectively calculate the delivery operation workload.

### CLAIM OF PRIORITY

This application claims priority to Korean Patent Application No. 10-2011-0045107 filed on May 13, 2011 in the Korean Intellectual Property Office (KIPO), the entire contents of which are hereby incorporated by reference.

### BACKGROUND

1. Technical Field

Example embodiments of the present invention relate in general to a method of calculating a delivery operation workload and an apparatus for the same, and more specifically to a method of calculating a delivery operation workload for each mail type and an apparatus for the same.

2. Related Art

A method of calculating a delivery operation workload typically involves rating and classifying nationwide distributing post offices into several types and assigning reference values to the respective types, or classifying the distributing post offices into urban A/B types, urban-rural A/B types, and rural A/B types, and assigning six reference values to the respective types in consideration of city size and population.

The delivery operation workload is thus calculated not for each mailman but for each distributing post office. In addition, when delivery operation workloads are calculated using the reference values for the predetermined types, the calculated workloads are quite different from actual workloads because the standard types into which the distributing post offices are sorted are not accurate. Thus, the conventional method of calculating delivery operation workloads has limited accuracy and reliability as a management model.

Therefore, it is necessary to provide a method of calculating delivery operation workloads in accordance with mail type and delivery environment for detailed delivery operations.

### SUMMARY

Accordingly, example embodiments of the present invention are provided to substantially obviate one or more problems due to limitations and disadvantages of the related art.

Example embodiments of the present invention provide a method of calculating delivery operation workloads by sorting routes of delivery operations and dividing the delivery operations into incidental operations and detailed delivery operations such as movement and delivery without sorting delivery types of nationwide distributing post offices, and an apparatus for the same.

Example embodiments of the present invention also provide a method of calculating delivery operation workloads by setting statistical reference values according to mail type and delivery environment on the basis of the mail type and a number of delivery points, and an apparatus for the same.

In some example embodiments, an apparatus for calculating a delivery operation workload includes: a route sorting time calculation unit configured to calculate a route sorting time on the basis of given same-day mail delivery information and delivery point information; a movement time calculation unit configured to calculate a movement time on the basis of the same-day mail delivery information and the delivery point information; a delivery time calculation unit configured to calculate a delivery time on the basis of the same-day mail delivery information and the delivery point information; an incidental operation time calculation unit configured to calculate an incidental operation time on the basis of the same-day mail delivery information and the delivery point information; and a delivery operation workload calculation unit configured to sum the calculated route sorting time, the movement time, the delivery time, and the incidental operation time, and to calculate the delivery operation workload on the basis of processing ability information for each mailman and delivery operation environment information.

In addition, the apparatus for calculating a delivery operation workload may further include a storage unit configured to store at least one of the same-day mail delivery information, the delivery point information, the processing ability information for each mailman, and the delivery operation environment information.

Here, the route sorting time calculation unit may calculate the route sorting time on the basis of mail delivery amount information and delivery score corresponding to respective mail type information and mail delivery environment information when the given same-day mail delivery information does not exceed a predetermined same-day mail delivery amount threshold, and may reconsider at least one of the mail delivery amount information and the delivery score when the given same-day mail delivery information exceeds the predetermined same-day mail delivery amount threshold.

Here, the movement time calculation unit may calculate the movement time on the basis of mail delivery distance information, mail delivery time information, and movement environment information when a movement distance for delivering the same-day delivery mail to the delivery point does not exceed a predetermined movement distance threshold, and may reconsider the movement distance when the movement distance exceeds the predetermined movement distance threshold.

Here, the delivery time calculation unit may calculate the delivery time on the basis of mail delivery amount information and delivery score corresponding to respective mail type information and mail delivery environment information when the delivery time for delivering the same-day delivery mail to the delivery point does not exceed a predetermined delivery time threshold, and may reconsider the delivery time when the delivery time exceeds the predetermined delivery time threshold.

Here, the incidental operation time calculation unit may sum the calculated movement time and the delivery time, calculate the incidental operation time on the basis of information on time consumed for variable and fixed works when the sum of the movement time and the delivery time does not exceed a predetermined threshold, and reconsider the calculated movement time, the delivery time, and a movement distance for delivering the mail to the delivery point when the sum of the movement time and the delivery time exceeds the predetermined threshold.

Here, the delivery operation workload calculation unit may sum the calculated route sorting time, the movement time, the delivery time, and the incidental operation time, and may calculate the delivery operation workload on the basis of at least one of career information, age information, and work shift information, of the mailman, and the delivery operation environment information.

In other example embodiments, a method of calculating a delivery operation workload carried out on an apparatus for calculating the delivery operation workload includes: calculating a route sorting time on the basis of given same-day mail delivery information and delivery point information; calculating a movement time on the basis of the same-day mail delivery information and the delivery point information; calculating a delivery time on the basis of the same-day mail delivery information and the delivery point information; calculating an incidental operation time on the basis of the same-day mail delivery information and the delivery point information; and summing the calculated route sorting time, the movement time, the delivery time, and the incidental operation time, and calculating the delivery operation workload on the basis of processing ability information for each mailman and delivery operation environment information.

Here, calculating the route sorting time on the basis of the given same-day mail delivery information and delivery point information may include calculating the route sorting time on the basis of mail delivery amount information and delivery score corresponding to respective mail type information and mail delivery environment information when the given same-day mail delivery information does not exceed a predetermined same-day mail delivery amount threshold, and reconsidering at least one of the mail delivery amount information and the delivery score when the given same-day mail delivery information exceeds the predetermined same-day mail delivery amount threshold.

Here, calculating the movement time on the basis of the same-day mail delivery information and the delivery point information may include calculating the movement time on the basis of mail delivery distance information, mail delivery time information, and movement environment information when a movement distance for delivering the same-day delivery mail to the delivery point does not exceed a predetermined movement distance threshold, and reconsidering the movement distance when the movement distance exceeds the predetermined movement distance threshold.

Here, calculating the delivery time on the basis of the same-day mail delivery information and the delivery point information may include calculating the delivery time on the basis of mail delivery amount information and delivery score corresponding to respective mail type information and mail delivery environment information when the delivery time for delivering the same-day delivery mail to the delivery point does not exceed a predetermined delivery time threshold, and reconsidering the delivery time when the delivery time exceeds the predetermined delivery time threshold.

Here, calculating the incidental operation time on the basis of the same-day mail delivery information and the delivery point information may include summing the calculated movement time and the delivery time and calculating the incidental operation time on the basis of information on time consumed for variable and fixed works when the sum of the movement time and the delivery time does not exceed a predetermined threshold, and reconsidering the calculated movement time, the delivery time, and a movement distance for delivering the mail to the delivery point when the sum of the movement time and the delivery time exceeds the predetermined threshold.

Here, summing the calculated route sorting time, the movement time, the delivery time and the incidental operation time and calculating the delivery operation workload on the basis of processing ability information for each mailman and delivery operation environment information may include summing the calculated route sorting time, the movement time, the delivery time, and the incidental operation time, and calculating the delivery operation workload on the basis of at least one of career information, age information, and work shift information, of the mailman, and the delivery operation environment information.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a configuration of an apparatus for calculating delivery operation workloads in accordance with an example embodiment;

FIGS. 2A and 2B are flowcharts illustrating a method of calculating delivery operation workloads that is carried out on the apparatus for calculating the delivery operation workloads in accordance with an example embodiment;

FIG. 3 is a flowchart specifically illustrating route sorting time calculation (S13) in the method of calculating the delivery operation workloads of FIG. 2;

FIG. 4 is a flowchart specifically illustrating delivery time calculation (S19) in the method of calculating the delivery operation workloads of FIG. 2;

FIG. 5 is a flowchart specifically illustrating movement time calculation (S16) in the method of calculating the delivery operation workloads of FIG. 2; and

FIG. 6 is a flowchart specifically illustrating incidental operation time calculation (S22) in the method of calculating the delivery operation workloads of FIG. 2.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

It should also be noted that in some alternative implementations, operations may be performed out of the sequences depicted in the flowcharts. For example, two operations shown in the drawings to be performed in succession may in fact be executed substantially concurrently or even in reverse of the order shown, depending upon the functionality/acts involved.

Meanwhile, example embodiments may be implemented by various means such as hardware, firmware, software, or a combination thereof. When the embodiments are implemented by hardware, they may be implemented by at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and so forth.

When the embodiments are implemented by firmware or software, they may be implemented in the form of modules, procedures, or functions carrying out actions or operations, the software code may be executed by the processor stored in a memory device, and the memory device may be installed inside or outside the processor to transceive data with the processor.

In addition, components to be described later are individually classified for convenience of description. At least two components may be combined to form one component, and one component may be divided into a plurality of components, in order to carry out functions. Such combination and division of components falls within the scope of the example embodiments.

Hereinafter, preferred example embodiments will be described in detail with reference to accompanying drawings.

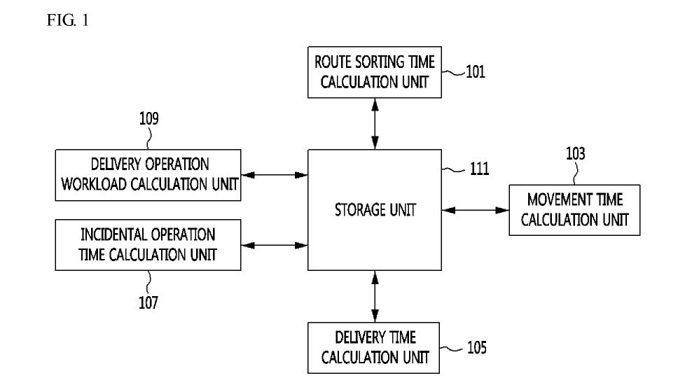

FIG. 1 is a block diagram illustrating a configuration of an apparatus for calculating delivery operation workloads in accordance with an example embodiment.

Referring to FIG. 1, an apparatus for calculating delivery operation workloads may include a route sorting time calculation unit 101, a movement time calculation unit 103, a delivery time calculation unit 105, an incidental operation time calculation unit 107, and a delivery operation workload calculation unit 109.

In addition, the apparatus for calculating delivery operation workloads may further include a storage unit 111.

The route sorting time calculation unit 101 may calculate the route sorting time on the basis of given same-day mail delivery information and delivery point information.

In particular, the route sorting time calculation unit 101 may calculate the route sorting time on the basis of mail delivery amount information and delivery score corresponding to respective mail type information and mail delivery environment information when the given same-day mail delivery information does not exceed a predetermined threshold of a same-day mail delivery amount, and may reconsider at least one of the mail delivery amount information and the delivery score when the given same-day mail delivery information exceeds the predetermined threshold of the same-day mail delivery amount.

Here, the same-day mail delivery information may include mail type information, mail delivery amount information for each mail type, mail delivery environment information, mail delivery amount information for each delivery environment, delivery score information for each mail type, delivery score information for each delivery environment, and so forth.

Here, the mail delivery environment information may include, but is not limited to, an apartment district, multiplex housing and duplex housing districts, officetel and complex shopping districts, detached and private business districts, public institutions/schools/hospitals, businesses, and so forth. In addition, the mail type information may include, but is not limited to, ordinary mail, registered mail, parcel, fast mail (FM), express mail service (EMS), and so forth.

The movement time calculation unit 103 may calculate the movement time on the basis of the same-day mail delivery information and the delivery point information.

In particular, the movement time calculation unit 103 may calculate the movement time on the basis of mail delivery distance information, mail delivery time information, and movement environment information when a movement distance for delivering the same-day delivery mail to the delivery point does not exceed a predetermined movement distance threshold, and may reconsider the movement distance when the movement distance exceeds the predetermined movement distance threshold.

The delivery time calculation unit 105 may calculate a delivery time on the basis of the same-day mail delivery information and the delivery point information.

In particular, the delivery time calculation unit 105 may calculate the delivery time on the basis of the mail delivery amount information and the delivery score corresponding to the respective mail type information and the mail delivery environment information when the delivery time for delivering the same-day delivery mail to the delivery point does not exceed a predetermined delivery time threshold, and may reconsider the delivery time when the delivery time exceeds the predetermined delivery time threshold.

The incidental operation time calculation unit 107 may calculate the incidental operation time on the basis of the same-day mail delivery information and the delivery point information.

In particular, the incidental operation time calculation unit 107 may sum the calculated movement time and delivery time, calculate the incidental operation time on the basis of information on time consumed for variable works and fixed works when the sum of the movement time and the delivery time does not exceed a predetermined threshold, and reconsider the calculated movement time, the delivery time, and the movement distance for delivering the mail to the delivery point when the sum of the movement time and the delivery time exceeds the predetermined threshold.

The delivery operation workload calculation unit 109 may sum the calculated route sorting time, the movement time, the delivery time, and the incidental operation time, and may calculate the delivery operation workload on the basis of processing ability information for each mailman and delivery operation environment information.

In particular, the delivery operation workload calculation unit 109 may sum the calculated route sorting time, the movement time, the delivery time, and the incidental operation time, and may calculate the delivery operation workload on the basis of at least one of career information, age information, and work shift information, of the mailman, and delivery operation environment information.

The storage unit 111 may store at least one of the same-day mail delivery information, delivery point information, the processing ability information for each mailman, and the delivery operation environment information.

Here, the processing ability information for each mailman may include the career information, age information, work shift information, and so forth, of the mailman.

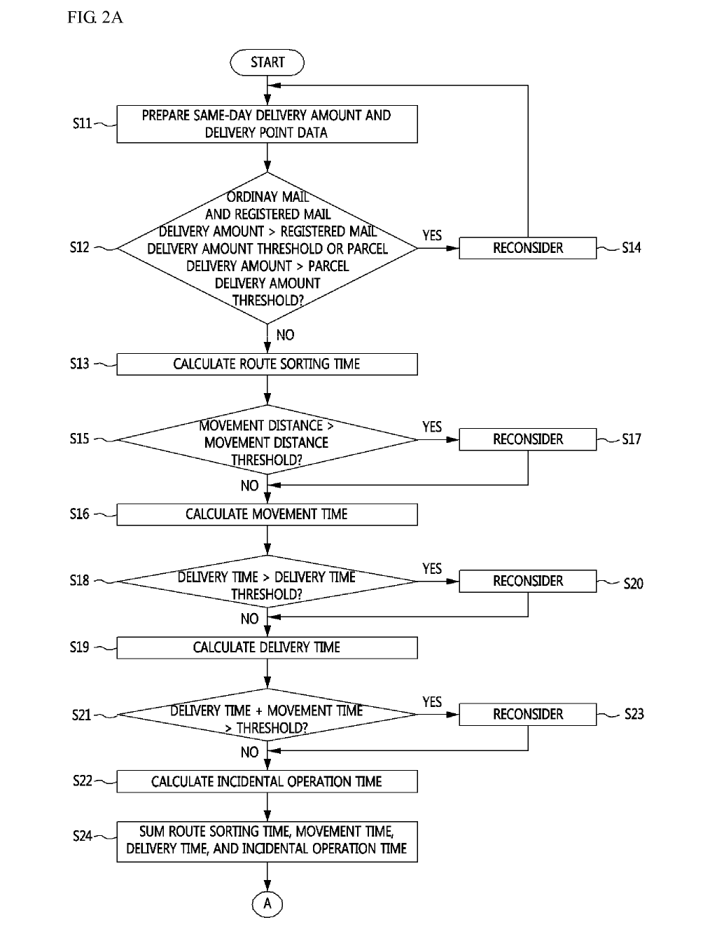

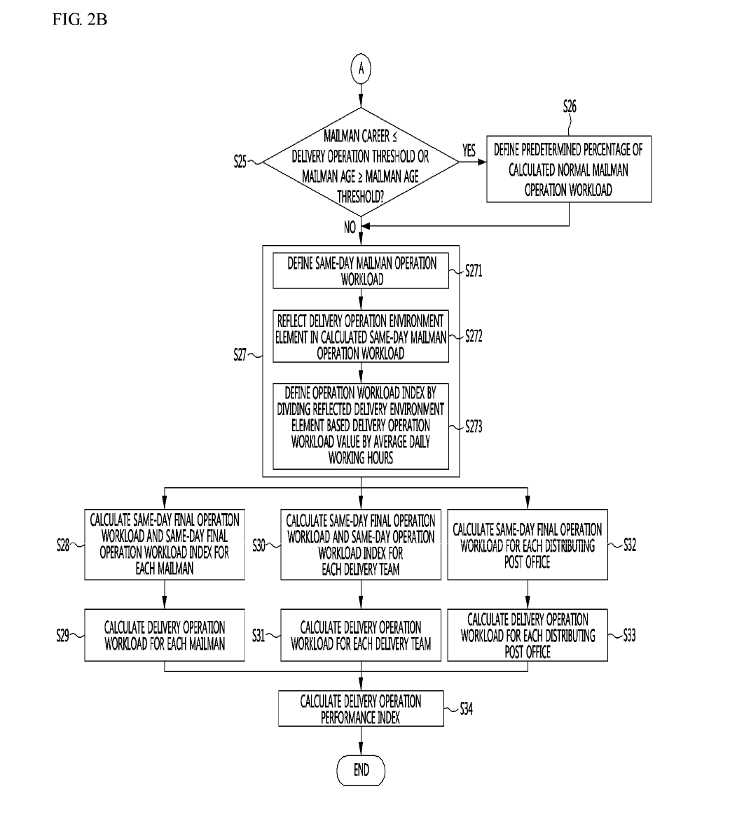

FIGS. 2A and 2B are flowcharts illustrating a method of calculating delivery operation workloads that is carried out on an apparatus for calculating the delivery operation workloads in accordance with an example embodiment.

Referring to FIGS. 2A and 2B, the method of calculating the delivery operation workloads carried out on the apparatus for calculating the delivery operation workloads may receive the same-day mail delivery information and the delivery point information (S11), and may calculate the route sorting time on the basis of the same-day mail delivery information and the delivery point information.

Here, the same-day mail delivery information may include same-day mail delivery amount information having ordinary and registered mail received from the distributing post offices.

In particular, the route sorting time may be calculated on the basis of the mail delivery amount information and the delivery score corresponding to the respective mail type information and the mail delivery environment information (S13) when given same-day mail delivery information does not exceed a predetermined threshold of the same-day mail delivery amount (S12), and at least one of the mail delivery amount information and the delivery score may be reconsidered (S14) when the given same-day mail delivery information exceeds the predetermined threshold of the same-day mail delivery amount.

The predetermined threshold of the same-day mail delivery amount may be a threshold for each mail type, or an added value of the thresholds for the respective mail types, for example, 10,000 or the like.

Next, the movement time may be calculated on the basis of the same-day mail delivery information and the delivery point information.

In particular, calculating the movement time on the basis of the same-day mail delivery information and the delivery point information may include calculating the movement time on the basis of the mail delivery distance information, the mail delivery time information, and the movement environment information (S16) when the movement distance for delivering the same-day delivery mail to the delivery point does not exceed a predetermined movement distance threshold (S15), and reconsidering the movement distance (S17) when the movement distance exceeds the predetermined movement distance threshold (S15).

Next, the delivery time may be calculated on the basis of the same-day mail delivery information and the delivery point information.

In particular, calculating the delivery time on the basis of the same-day mail delivery information and the delivery point information may calculate the delivery time on the basis of the mail delivery amount information and the delivery score corresponding to the respective mail type information and the mail delivery environment information (S19) when the delivery time for delivering the same-day delivery mail to the delivery point does not exceed a predetermined delivery time threshold (S18), and may reconsider the delivery time (S20) when the delivery time for delivering the same-day delivery mail to the delivery point exceeds the predetermined delivery time threshold (S18).

Next, the incidental operation time may be calculated on the basis of the same-day mail delivery information and the delivery point information.

In particular, calculating the incidental operation time on the basis of the same-day mail delivery information and the delivery point in formation may include summing the calculated movement time and delivery time, calculating the incidental operation time on the basis of information on time consumed for variable works and fixed works (S22) when the sum of the movement time and the delivery time does not exceed a predetermined threshold (S21), and reconsidering the calculated movement time, the delivery time, and the movement distance for delivering the mail to the delivery point (S23) when the sum of the movement time and the delivery time exceeds the predetermined threshold (S21).

Next, the calculated route sorting time, the movement time, the delivery time, and the incidental operation time may be added (S24), and the delivery operation workload may be calculated on the basis of the processing ability information for each mailman and the delivery operation environment information.

In particular, summing the calculated route sorting time, the movement time, the delivery time, and the incidental operation time and calculating the delivery operation workload on the basis of the processing ability for each mailman and the delivery operation environment information may include summing the calculated route sorting time, the movement time, the delivery time, and the incidental operation time (S24), and calculating the delivery operation workload on the basis of at least one of the career information, the age information, the work shift information, of the mailman, and the delivery operation environment information.

Next, it may be determined whether the career information of the mailman for the calculated delivery operation workload is equal to or higher than a delivery operation threshold or whether the age information of the mailman for the calculated delivery operation workload is equal to or lower than a mailman age threshold (S25), and the delivery operation workload can be saved by a predetermined percentage of the calculated delivery operation workload when the career information is equal to or lower than the delivery operation threshold or when the age information is equal to or higher than the mailman age threshold.

On the other hand, when the career information of the mailman for the calculated delivery operation workload is equal to or higher than the delivery operation threshold, or when the age information of the mailman for the calculated delivery operation workload is equal to or lower than the mailman age threshold, the calculated delivery operation workload may be determined as the same-day delivery operation workload (S271), the delivery operation environment information may be reflected in the determined same-day delivery operation workload (S272), and the same-day delivery operation workload in which the delivery operation environment information is reflected may be divided by total daily working hours, for example, 8, thereby finally obtaining a same-day delivery operation workload index (S273).

Next, on the basis of the calculated same-day delivery operation workload and the same-day delivery operation workload index, a same-day delivery operation workload for each mailman, a same-day delivery operation workload index for each mailman, a same-day delivery operation workload and a same-day delivery operation workload index for each delivery team, and a same-day delivery operation workload and a same-day delivery operation workload index for each distributing post office may be calculated for a given period (S28, S30 and S32).

Next, the calculated same-day delivery operation workload and the same-day delivery operation workload index for each mailman, the calculated same-day delivery operation load and the same-day delivery operation workload index for each delivery team, and the calculated same-day delivery operation workload and the same-day delivery operation workload index for each distributing post office may be used to calculate the delivery operation workload for each mailman, the delivery operation workload for each delivery team, and the delivery operation workload for each distributing post office (S29, S31, and S33).

Next, a delivery operation performance index may be calculated on the basis of the calculated delivery operation workload for each mailman, the calculated delivery operation workload for each delivery team, and the calculated delivery operation workload for each distributing post office (S34).

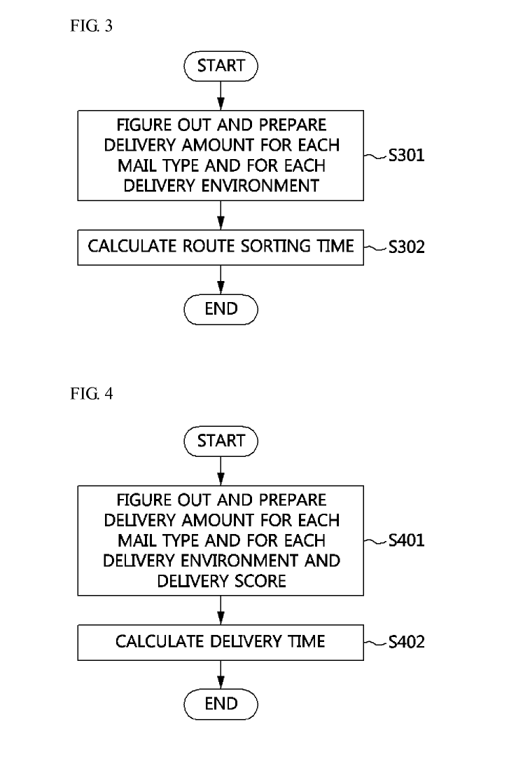

FIG. 3 is a flowchart specifically illustrating route sorting time calculation (S13) in the method of calculating the delivery operation workloads of FIG. 2.

Referring to FIG. 3, calculating the route sorting time may include calculating the route sorting time on the basis of the same-day mail delivery information and the delivery point information.

Here, the same-day mail delivery information may include the same-day mail delivery amount information having ordinary and registered mail received from the distributing post offices.

In particular, the mail amount information for each mail type such as ordinary mail, registered mail, parcel, FM, and EMS, and delivery scores, and the mail delivery amount information for each mail delivery environment such as an apartment district, multiplex housing and duplex housing districts, officetel and complex shopping districts, detached and private business districts, public institutions/schools/hospitals, and businesses, and delivery scores may be figured out and prepared (S301).

For example, the route delivery sorting time (DST) may be calculated on the basis of Equation 1 below:

$$DST = {T}_{1} + {T}_{2} + {T}_{3} + {T}_{4} = {\sum }_{i = 1}^{k} {T}_{i} = DST ( manual operation for small \text{-} sized ordinary mail ) + DST ( machine for small \text{-} sized ordinary mail ) + DST ( manual operation for large \text{-} sized ordinary mail ) + DST ( registered mail ) + DST ( parcel ) + DST ( EMS ) + DST ( fast mail ) \qquad Equation 1$$

Referring to Equation 1, T₁ indicates the manual operation time for sorting mail delivery orders including mailman/course/orders, and T₂ indicates the machine operation time for sorting mail delivery orders including the mailman/course/orders. T₃ indicates the manual operation time for mail connection, and T₄ indicates the manual operation time for bundling mail.

DST indicates the route delivery sorting time in accordance with the delivery environment for each mail type such as small-sized ordinary mail (ordinary letter by person (OLP), ordinary letter by machine (OLM)), large-sized ordinary mail (OLL), registered mail (RM), parcels (P), EMS, and FM, and the route delivery sorting time for small-sized ordinary mail DST_{(OLP)} is defined as Equation 2 below:

$${DST}_{( OLP )} = {m}_{11} \frac{{a}_{1}}{a} \times {ts}_{11} + {m}_{12} \frac{{a}_{2}}{a} \times {ts}_{12} + {m}_{13} \frac{{a}_{3}}{a} \times {ts}_{13} + {m}_{14} \frac{{a}_{4}}{a} \times {ts}_{14} + {m}_{15} \frac{{a}_{5}}{a} \times {ts}_{15} \qquad Equation 2$$

Referring to Equation 2, m₁₁ indicates the amount of manual operation for small-sized ordinary mail. a indicates the total delivery score, a₁ indicates the apartment delivery score, and ts₁₁ indicates the route reference time for apartment delivery environment.

a₂ indicates the delivery score for duplex housing/multiplex housing, and ts₁₂ indicates the route reference time for duplex housing/multiplex housing delivery environment. a₃ indicates the delivery score for business/public institutions/school/hospital, and ts₁₃ indicates the route reference time for business/public institutions/school/hospital delivery environment.

a₄ indicates the delivery score for officetel/large-sized detached building, and ts₁₄ indicates the route reference time for officetel/large-sized detached building delivery environment. a₅ indicates the delivery score for detached house/private business, and ts₁₅ indicates the route reference time for detached house/private business delivery environment.

In addition to the route delivery sorting time DST_{(OLP)} for small-sized ordinary mail, DST_{(OLM)}, route delivery sorting time for DST_{(OLL)}, DST_{(RM)}, DST_{(P)}, DST_{(EMS)}, and DST_{(FM)} may also be defined in a similar way.

FIG. 4 is a flowchart specifically illustrating delivery time calculation (S19) in the method of calculating the delivery operation workloads of FIG. 2.

Referring to FIG. 4, calculating the delivery time may be done on the basis of the same-day mail delivery information and the delivery point information.

Here, the same-day mail delivery information may include the same-day mail delivery amount information having ordinary and registered mail received from distributing post offices.

In particular, the mail amount information for each mail type, such as ordinary mail, registered mail, parcel, FM, and EMS, and delivery scores thereof, and the mail amount information for each mail delivery environment, such as an apartment district, multiplex housing and duplex housing districts, officetel and complex shopping districts, detached and private business districts, public institutions, schools, hospitals, and businesses, and delivery scores thereof, may be figured out and prepared (S401).

For example, the delivery time for each mail type may be calculated using Equation 3 below (S402):

$$DT = {T}_{1} + {T}_{2} = {\sum }_{i = 1}^{k} {T}_{i} \qquad Equation 3$$

T₁=DT_{(OL)}+DT_{(RM)}+DT_{(P)}+DT_{(EMS)}+DT_{(FM)}+DT_{(IPP)}+DT_{(CPP)}+DT_{(DM)}

T₂=foot movement distance within building and inter-building/S₄

Referring to Equation 3, T₁ indicates the time for delivering the mail to a customer, and T₂ indicates the foot movement time for delivering the mail.

DT indicates the delivery time in accordance with the delivery environment for each mail type such as small-sized ordinary mail (OLP, OLM), large-sized ordinary mail (OLL), RM, parcels (P), EMS, FM, irregular parcels and pieces (IPP), contracted parcel pickup (CPP), and mailbox collection (MB). The delivery time for small-sized ordinary mail DST_{(OL)} is defined as Equation 4 below:

$${DT}_{( individual ordinary mail )} = {m}_{11} \frac{{a}_{1}}{a} \times {td}_{11} + {m}_{11} \frac{{a}_{2}}{a} \times {td}_{12} + {m}_{11} \frac{{a}_{3}}{a} \times {td}_{13} + {m}_{11} \frac{{a}_{4}}{a} \times {td}_{14} + {m}_{11} \frac{{a}_{5}}{a} \times {td}_{15}$$

$${DT}_{( batch ordinary mail )} = {n}_{1} \frac{{a}_{1}}{a} \times {td}_{11} + {n}_{1} \frac{{a}_{2}}{a} \times {td}_{12} + {n}_{1} \frac{{a}_{3}}{a} \times {td}_{13} + {n}_{1} \frac{{a}_{4}}{a} \times {td}_{14} + {n}_{1} \frac{{a}_{5}}{a} \times {td}_{15}$$

Referring to Equation 4, m₁₁ indicates the ordinary mail delivery amount, and n₁ indicates the score of the ordinary mail delivery amount. a indicates the total delivery score, a1 indicates the apartment delivery score, and td₁₁ indicates the route sorting time for the apartment delivery environment. a₂ indicates the delivery score for the duplex housing/multiplex housing, and td₁₂ indicates the delivery reference time for the duplex housing/multiplex housing delivery environment. a₃ indicates the delivery score for the business/public institutions/school/hospital, and td₁₃ indicates the route reference time for the business/public institutions/school/hospital delivery environment.

a₄ indicates the delivery score for the officetel/large-sized detached building, and td₁₄ indicates the route reference time for the officetel/large-sized detached building delivery environment. a₅ indicates the delivery score for the detached house/private business, and td₁₅ indicates the route reference time for the detached house/private business delivery environment.

In addition to the delivery time for small-sized ordinary mail DT_{(OL)}, DT_{(OLM)}, delivery time for large-sized ordinary mail DT_{(OLL)}, DT_{(RM)}, DT_{(P)}, DT_{(EMS)}, and DT_{(FM)} may also be defined similarly.

FIG. 5 is a flowchart specifically illustrating movement time calculation (S16) in the method of calculating the delivery operation workloads of FIG. 2. Referring to FIG. 5, calculating the movement time may be carried out, for example, by figuring out and preparing the movement time, the departure time from the post office, the return time to the post office, the delivery time, and the movement environment such as big cities, small and medium-sized cities, and farming and fishing villages (S501), and calculating the movement time on the basis of Equation 5 below (S502):

MT_{(general)}=[return time−departure time]−delivery time=vehicle(motorcycle)movement distance/S₁[S₂,S₃]

MT_{(FM)}=[[return time−departure time]−delivery time]]×q=[vehicle(motorcycle)movement distance/S₁[S₂,S₃]×q Equation 5

Referring to Equation 5, S₁ indicates an averate speed (/km) in the bit city (vehicle), S₂ indicates an averate speed (/km) in the small and medium-sized city (vehicle), S₃ indicates an averate speed (/km) in the farming and fishing villages (vehicle), and q indicates the number of departures.

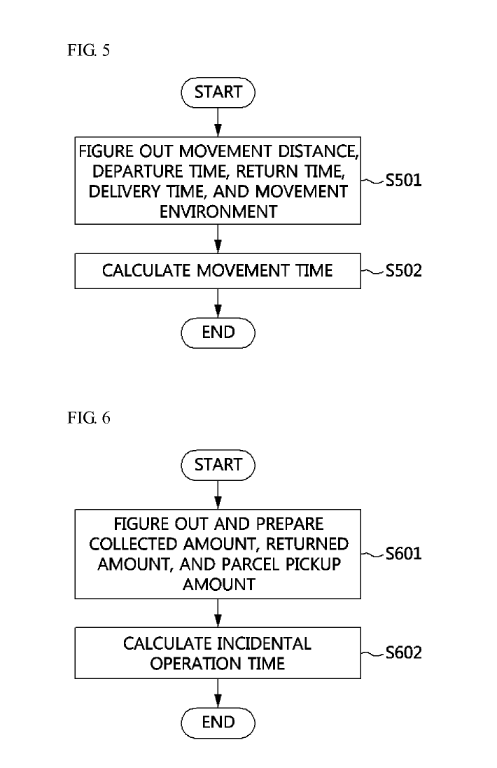

FIG. 6 is a flowchart specifically illustrating incidental operation time calculation (S22) in the method of calculating the delivery operation workloads of FIG. 2.

Referring to FIG. 6, calculating the incidental operation time may be carried out by figuring out and preparing mail collection and return and a mail pickup amount (S601), and using Equation 6 below (S602):

ADW_{(general)}=variable work time[VWT]+fixed work time[FWT_{(general)}]

VMT=m₆×tadw₁+m₇×tadw₂+m₉×tadw₃

FWT_{(general)}=DRPT_{(general)}+SUT_{(general)}+OT Equation 6

Referring to Equation 6, tadw₁ indicates the reference time for processing the parcel pickup, tadw₂ indicates the reference time for processing the collected mail, and tadw₃ indicates the reference time for processing the returned mail. In addition, m₆ indicates the parcel pickup amount, m₇ indicates the collected mail amount, and m₉ indicates the returned mail amount.

DRPT_{(general)} indicates the time for processing the delivery result, SUT_{(general)} indicates the system registration time, and OT indicates other incidental operation times, for example, safety and customer service education, loaded mail, and so forth.

According to the method of calculating delivery operation workloads and the apparatus for the same described above, the delivery operation workloads can be more objectively calculated, and the delivery operations can thus be adjusted and averaged. In addition, it is expected that the delivery operations be effective and customer service be enhanced. In addition, the example embodiments can also be applied to calculation of workloads of door-to-door delivery serviceman operations even in general delivery operation environment.

While the example embodiments of the present invention and their advantages have been described in detail, it should be understood that various changes, substitutions and alterations may be made herein without departing from the scope of the invention.

What is claimed is:

1. A method of calculating a delivery operation workload carried out on an apparatus for calculating the delivery operation workload, the method comprising:
calculating a route sorting time on the basis of given same-day mail delivery information and delivery point information;
calculating a movement time on the basis of the same-day mail delivery information and the delivery point information;
calculating a delivery time on the basis of the same-day mail delivery information and the delivery point information;
calculating an incidental operation time on the basis of the same-day mail delivery information and the delivery point information; and
summing the calculated route sorting time, the movement time, the delivery time, and the incidental operation time, and calculating the delivery operation workload on the basis of processing ability information for each mailman and delivery operation environment information.

2. The method of claim 1, wherein calculating the route sorting time on the basis of the given same-day mail delivery information and delivery point information includes calculating the route sorting time on the basis of mail delivery amount information and delivery score corresponding to respective mail type information and mail delivery environment information when the given same-day mail delivery information does not exceed a predetermined same-day mail delivery amount threshold, and reconsidering at least one of the mail delivery amount information and the delivery score when the given same-day mail delivery information exceeds the predetermined same-day mail delivery amount threshold.

3. The method of claim 1, wherein calculating the movement time on the basis of the same-day mail delivery information and the delivery point information includes calculating the movement time on the basis of mail delivery distance information, mail delivery time information, and movement environment information when a movement distance for delivering the same-day delivery mail to the delivery point does not exceed a predetermined movement distance threshold, and reconsidering the movement distance when the movement distance exceeds the predetermined movement distance threshold.

4. The method of claim 1, wherein calculating the delivery time on the basis of the same-day mail delivery information and the delivery point information includes calculating the delivery time on the basis of mail delivery amount information and delivery score corresponding to respective mail type information and mail delivery environment information when the delivery time for delivering the same-day delivery mail to the delivery point does not exceed a predetermined delivery time threshold, and reconsidering the delivery time when the delivery time exceeds the predetermined delivery time threshold.

5. The method of claim 1, wherein calculating the incidental operation time on the basis of the same-day mail delivery information and the delivery point information includes summing the calculated movement time and the delivery time and calculating the incidental operation time on the basis of information on time consumed for variable and fixed works when the sum of the movement time and the delivery time does not exceed a predetermined threshold, and reconsidering the calculated movement time, the delivery time, and a movement distance for delivering the mail to the delivery point when the sum of the movement time and the delivery time exceeds the predetermined threshold.

6. The method of claim 1, wherein summing the calculated route sorting time, the movement time, the delivery time and the incidental operation time and calculating the delivery operation workload on the basis of processing ability information for each mailman and delivery operation environment information includes summing the calculated route sorting time, the movement time, the delivery time, and the incidental operation time, and calculating the delivery operation workload on the basis of at least one of career information, age information, and work shift information, of the mailman, and the delivery operation environment information.

7. An apparatus for calculating a delivery operation workload, comprising:
a route sorting time calculation unit configured to calculate a route sorting time on the basis of given same-day mail delivery information and delivery point information;
a movement time calculation unit configured to calculate a movement time on the basis of the same-day mail delivery information and the delivery point information;
a delivery time calculation unit configured to calculate a delivery time on the basis of the same-day mail delivery information and the delivery point information;
an incidental operation time calculation unit configured to calculate an incidental operation time on the basis of the same-day mail delivery information and the delivery point information; and
a delivery operation workload calculation unit configured to sum the calculated route sorting time, the movement time, the delivery time, and the incidental operation time, and to calculate the delivery operation workload on the basis of processing ability information for each mailman and delivery operation environment information.

8. The apparatus of claim 7, further comprising:
a storage unit configured to store at least one of the same-day mail delivery information, the delivery point information, the processing ability information for each mailman, and the delivery operation environment information.

9. The apparatus of claim 7, wherein the route sorting time calculation unit calculates the route sorting time on the basis of mail delivery amount information and delivery score corresponding to respective mail type information and mail delivery environment information when the given same-day mail delivery information does not exceed a predetermined same-day mail delivery amount threshold, and reconsiders at least one of the mail delivery amount information and the delivery score when the given same-day mail delivery information exceeds the predetermined same-day mail delivery amount threshold.

10. The apparatus of claim 7, wherein the movement time calculation unit calculates the movement time on the basis of mail delivery distance information, mail delivery time information, and movement environment information when a movement distance for delivering the same-day delivery mail to the delivery point does not exceed a predetermined movement distance threshold, and reconsiders the movement distance when the movement distance exceeds the predetermined movement distance threshold.

11. The apparatus of claim 7, wherein the delivery time calculation unit calculates the delivery time on the basis of mail delivery amount information and delivery score corresponding to respective mail type information and mail delivery environment information when the delivery time for delivering the same-day delivery mail to the delivery point does not exceed a predetermined delivery time threshold, and reconsiders the delivery time when the delivery time exceeds the predetermined delivery time threshold.

12. The apparatus of claim 7, wherein the incidental operation time calculation unit adds the calculated movement time and the delivery time, calculates the incidental operation time on the basis of information on time consumed for variable and fixed works when the sum of the movement time and the delivery time does not exceed a predetermined threshold, and reconsiders the calculated movement time, the delivery time, and a movement distance for delivering the mail to the delivery point when the sum of the movement time and the delivery time exceeds the predetermined threshold.

13. The apparatus of claim 7, wherein the delivery operation workload calculation unit adds the calculated route sorting time, the movement time, the delivery time, and the incidental operation time, and calculates the delivery operation workload on the basis of at least one of career information, age information, and work shift information, of the mailman, and the delivery operation environment information.
